(19) United States
(12) Patent Application Publication
(10) Pub. No.: US 2019/0079916 A1
(43) Pub. Date: Mar. 14, 2019

(54) USING SYNTACTIC ANALYSIS FOR INFERRING MENTAL HEALTH AND MENTAL STATES

(71) Applicant: INTERNATIONAL BUSINESS MACHINES CORPORATION, Armonk, CA (US)

(72) Inventor: Elif Eyigoz, Lake Peekskill, NY (US)

(21) Appl. No.: 15/700,291

(22) Filed: Sep. 11, 2017

(51) Int. Cl. G06F 17/27; G06F 19/00

(52) U.S. Cl. CPC G06F 17/271; G06F 19/345; G06F 17/2715

(57) ABSTRACT

A computing device may receive a text and parse the text into a syntactic tree. The computing device may determine binary relations and trinary relations within the plurality of node pairs and the plurality of node triples. The computing device may select a plurality of important node pairs and node triples from the plurality of node pairs and node triples. The computing device may calculate a plurality of probabilities within relations of the plurality of the important node pairs and the plurality of the important node triples. The computing device may calculate a plurality of statistics for the relations based on the calculated plurality of probabilities. The computing device may determine a score and a probability associated with the score using the calculated plurality of probabilities and the calculated plurality of statistics with a trained neural network, and may display the determined score and the determined probability.

### BACKGROUND

The present invention relates, generally, to the field of computing, and more particularly to using Natural Language Processing (NLP) and human mental state diagnostics.

NLP is a field of computer science, artificial intelligence, and computational linguistics related to the interactions between computers and human natural languages, such as programming computers to process and analyze natural language corpora. A subfield of NLP is computational linguistics that is concerned with the statistical or rule-based modeling of natural language from a computational perspective. An applied computational linguistics focuses on the practical outcome of modeling human language use, such as converting a string onto a parse tree. A parse tree is an ordered data structure that may be represented as a rooted graph in a form of a tree that represents the syntactic structure of the string according to some context-free grammar approach.

### SUMMARY

According to one embodiment, a method, computer system, and computer program product for determining a mental state of a user by syntactic analysis of a text associated with the user is provided. The present invention may include a computing device receives a text and parses the text into a syntactic tree where the syntactic tree comprises a plurality of node pairs and a plurality of node triples. The computing device may determine one or more binary relations and one or more trinary relations within the plurality of node pairs and the plurality of node triples, where the one or more binary relations and trinary relations are associated with the plurality of node pairs. The computing device may select a plurality of important node pairs and node triples from the plurality of node pairs and node triples, where the plurality of the important node pairs and node triples are determined by the binary and trinary relations respectively. The computing device may calculate a plurality of probabilities within one or more relations of the plurality of the important node pairs and the plurality of the important node triples. The computing device may calculate a plurality of statistics for the one or more relations based on the calculated plurality of probabilities. The computing device may determine a score and a probability associated with the score using the calculated plurality of probabilities and the calculated plurality of statistics with a trained neural network, and may display the determined score and the determined probability.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is a syntactic tree of a string according to at least one embodiment;

FIG. 3 is an operational flowchart illustrating a syntactic analysis process according to at least one embodiment;

FIG. 4 is a block diagram of internal and external components of computers and servers depicted in FIG. 1 according to at least one embodiment;

FIG. 5 depicts a cloud computing environment according to an embodiment of the present invention; and

FIG. 6 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to using Natural Language Processing (NLP) and human mental state diagnostics. The following described exemplary embodiments provide a system, method, and program product to, among other things, parse an input text of a user using a syntactic parser, analyze statistically the relations between the nodes of the parsed input text, and use the statistical data as an input to a trained neural network in order to determine a mental state of a user. Therefore, the present embodiment has the capacity to improve an accuracy and promptness of autonomous user mental impairment assessment by using statistical data extracted from the text that is analyzed by the trained neural network that improves an accuracy of mental treatment administration.

As previously described, a subfield of NLP is computational linguistics that is concerned with the statistical or rule-based modeling of natural language from a computational perspective. An applied computational linguistics focuses on the practical outcome of modeling human language use, such as converting a string onto a parse tree. A parse tree is an ordered data structure that may be represented as a rooted graph in a tree format that represents the syntactic structure of the string according to some context-free grammar approaches.

A user mental impairment or neurological disorder may be inferred from user responses to questions or during conversation. Different neurological disorders have various impacts on speech and, therefore, by analyzing the user responses, a neurological disorder may be detected.

Typically, the evaluation of the disorder is performed by a professional, such as a doctor or a psychiatrist, who may misdiagnose the neurological disorder due to lack of knowledge, inattention or a human error. Using a computerized system, combining machine learning with word relation extractions based on the syntactic tree may reduce misdiagnosis made due to human error. As such, it may be advantageous to, among other things, implement a system that receives user speech converted to text, analyzes the text using syntactical parsing, relation extraction and neural networks to calculate a probability score that may be used in diagnosing the disorder, and suggesting an appropriate treatment for the disorder. For example, when a user suffers from Alzheimer's disease is asked to describe a picture, the user may typically respond in specific patterns, such as short sentences that fail to identify the main aspects of a picture.

According to one embodiment, a processor-implemented method may receive a user response and parse the converted to text response into a syntactic tree. The syntactic tree may be analyzed for binary relations and trinary relations within the nodes of the parsed tree. After determination of the important binary relations and trinary relations statistics, the relations may be determined and used by a trained neural network in order to determine a score associated with a mental impairment of a user and a probability value representing the likelihood of the mental impairment of the user. In addition, the method may determine and administer an appropriate treatment for the mental impairment associated with the score. In another embodiment, the method may be used in order to determine whether the user is in a mental state to take an action for a certain procedure. For example, if a user consent is needed in order to perform a surgery, a computing device may ask the user to answer specific questions and after analyzing the user response the method may determine whether the user is in a mental state to consent to the procedure.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to create a model based on historical user information and meeting information that is capable of automatically modifying the contents of a computer display screen shared during a screen sharing session.

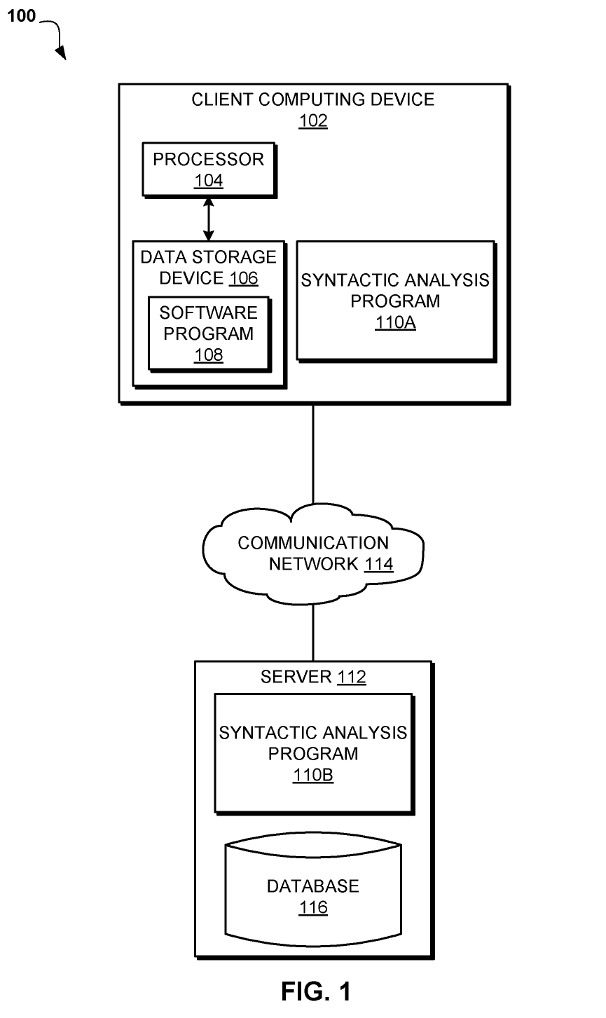

Referring to FIG. 1, an exemplary networked computer environment 100 is depicted, according to at least one embodiment. The networked computer environment 100 may include client computing device 102 and a server 112 interconnected via a communication network 114. According to at least one implementation, the networked computer environment 100 may include a plurality of client computing devices 102 and servers 112, of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

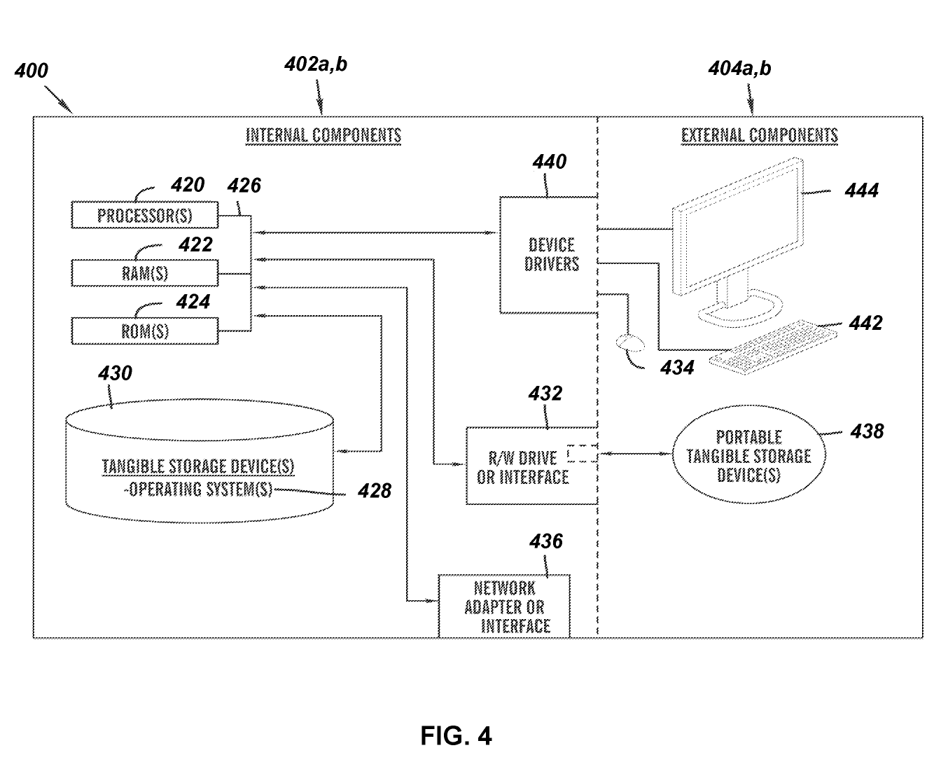

Client computing device 102 may include a processor 104 and a data storage device 106 that is enabled to host and run a software program 108 and a syntactic analysis program 110A and communicate with the server 112 via the communication network 114, in accordance with one embodiment of the invention. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 4 the client computing device 102 may include internal components 402a and external components 404a, respectively.

The server computer 112 may be a laptop computer, netbook computer, personal computer (PC), a desktop computer, or any programmable electronic device or any network of programmable electronic devices capable of hosting and running a syntactic analysis program 110B and a database 116 and communicating with the client computing device 102 via the communication network 114, in accordance with embodiments of the invention. As will be discussed with reference to FIG. 4 the server computer 112 may include internal components 402b and external components 404b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

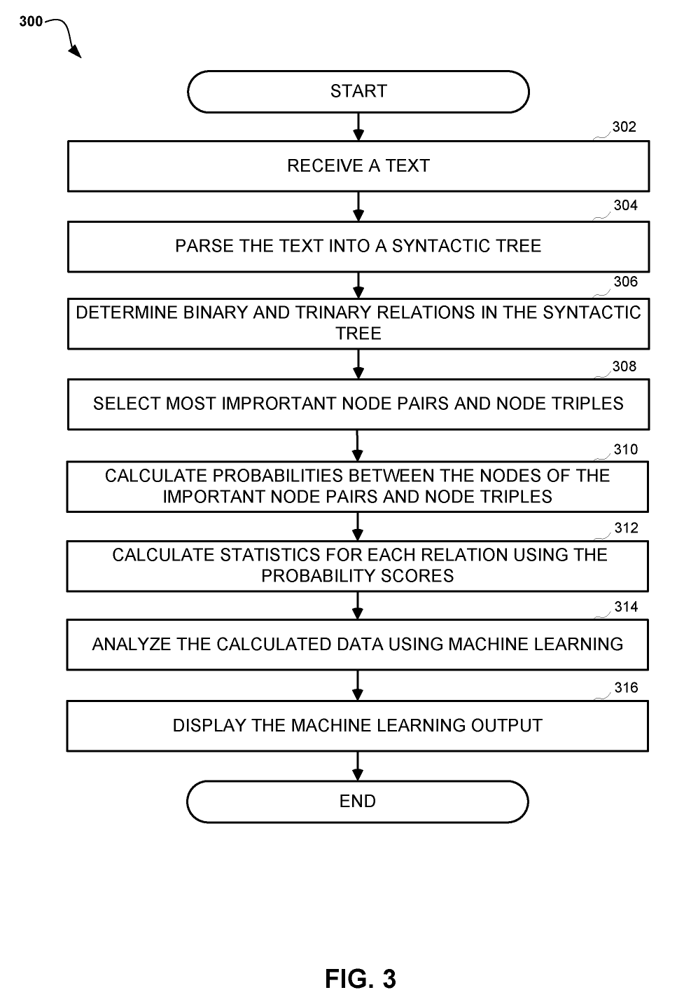

According to the present embodiment, the syntactic analysis program 110A, 110B may be a program capable of receiving a user response in a text format, parsing the text into a syntactic tree in order to analyze the relationships between the nodes of a syntactic tree and use the analyzed data by a trained neural network in order to determine a mental impairment of a user. In another embodiment, syntactic analysis program 110A, 110B may administer a treatment, such as an appropriate medication that may reduce the symptoms or cure the disorder. In further embodiments, the syntactic analysis program 110A, 110B may allow or reject certain procedures based on a mental state without human intervention, such as a user consent to a surgery, a user consent to transfer money or perform other actions where the user mental state has to be assessed before performing the action. The method for assessing mental impairment and mental state of the user is explained in further detail below with respect to FIG. 3.

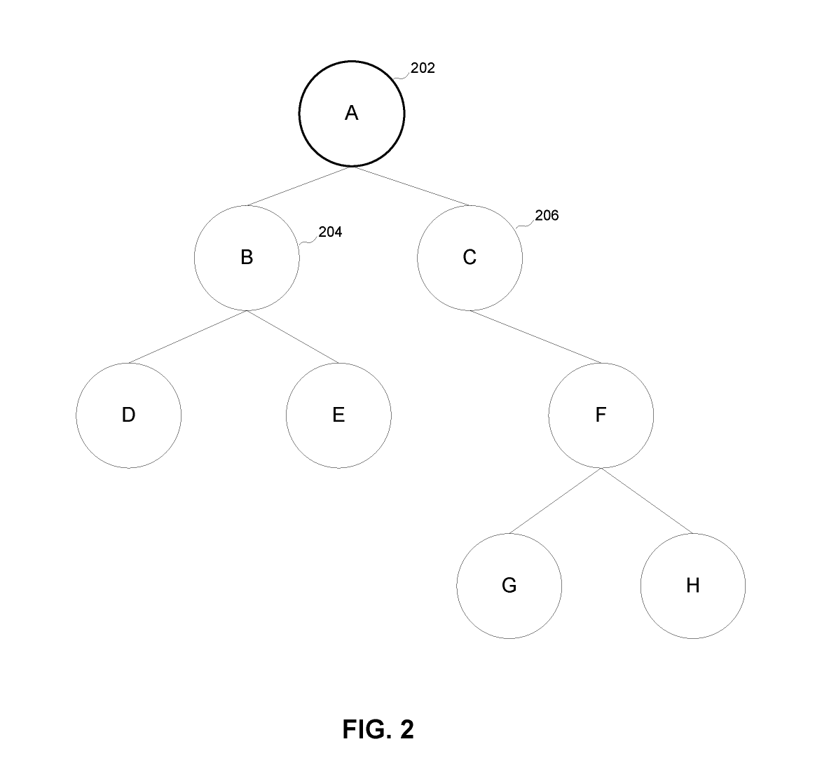

Referring now to FIG. 2, a syntactic tree of a string according to at least one embodiment is depicted. According to at least one embodiment, a string may be a sequence of words and phrases from a text that may represent a single sentence in a natural language.

The syntactic tree may be depicted as a directed acyclic graph, whose undirected version has no cycles. The syntactic tree may have a root 202 that may have a rank of zero, that may be connected to one or more leaves of the tree, such as node 204 and node 206 that may have outrank of 0. According to at least one embodiment, each root such as root 202 may represent a beginning and a pointer to a sentence from the text, and each node, such as node 204 and node 206 may represent a word or phrase in the sentence. Binary and trinary relations may be defined and determined between the nodes of a syntactic tree.

Binary relations may be defined as: (i) a node may be a parent when the node has at least one node that is connected to it. For example, in node pair (A,B), node A is a parent of node B and node C; (ii) in a node pair (B,C) either node B or Node C may be a sister node because node B and node C have the same parent, node A. For example, nodes B and C may be sister nodes since they share the same parent (i.e., node A); (iii) in a node pair (B,C) node B may be a dominance node that may be defined as a number (k-dominance) representing a “distance” between a parent node to a connected node. For example, node A may have dominance of 2 over node D since node A dominates node D through node B; and (iv) a command may be defined when a node is a sister to a node that dominates another node. For example node B may command node G since node C is a sister node to node B and node C dominates node G.

Trinary relations may be defined as: (i) command-via-maximal, such as node triple (B,A,F) where B may command F, when A is a mother of B and A k-dominates F; (ii) Command-via-mother, such as node triple (B,C,F) where B commands F and C is a mother of F; and (iii) Dominate-transitive node triple (A,B,D) where A k-dominates B and B k-dominates D.

Referring now to FIG. 3, an operational flowchart illustrating a syntactic analysis process 300 is depicted according to at least one embodiment. At 302, the syntactic analysis program 110A, 110B receives a text. According to at least one embodiment, the syntactic analysis program 110A, 110B may receive a transcription of a user response to a specific or general question. For example, a user may be shown a picture and required to explain what is depicted in the picture while the response is transcribed to text. The text may be received from a text file stored in data storage device 106, database 116 or received from communication network 114. In another embodiment, the syntactic analysis program 110A, 110B may receive voice data, such as recorded voice data extracted from a video or a video stream and convert the voice data into a text file using speech-to-text techniques.

Next, at 304, the syntactic analysis program 110A, 110B parses the text into a syntactic tree, such as a syntactic tree depicted in FIG. 2. According to at least one embodiment, the syntactic analysis program 110A, 110B may apply a natural language parser to a text and converts it into a large number of parse trees that may be stored in the form of an array or database 116. For example, a statistical parser may be applied to convert the text into a large number of parse trees, such as a Stanford parser.

Next, at 306, the syntactic analysis program 110A, 110B determines binary and trinary relations in the syntactic tree. According to at least one embodiment, the syntactic analysis program 110A, 110B may determine binary relations, and arrange and save the relations in a matrix form, such as a spreadsheet or a 2D array. Afterwards, syntactic analysis program 110A, 110B may determine trinary relations between the nodes of the parse tree and arrange and save the trinary relations probabilities in another matrix form. For example, for each binary relation, syntactic analysis program 110A, 110B may count a number of times a specific node pair appears in that relation, such as dominance relations, and may store the counts in a matrix form. In another embodiment, syntactic analysis program 110A, 110B may store all the relations in a joint matrix where each relation may be assigned a separate row or column of the matrix.

Next, at 308, the syntactic analysis program 110A, 110B selects most important node pairs and node triples. According to at least one embodiment, syntactic analysis program 110A, 110B may select the most important node pairs and node triples by statistically analyzing the matrices that store the relations between nodes. For example, the syntactic analysis program 110A, 110B may select the most important node pairs and node triples by factorization of the matrices, such as by determining Singular Value Decomposition (SVD) of the matrices. In another embodiment, the most important node pairs and node triples may be selected based on a threshold value, such as when the same node pairs and node triples appear more than a threshold value.

Next, at 310, the syntactic analysis program 110A, 110B calculates probabilities between the nodes of the important node pairs and the node triples. According to at least one embodiment, syntactic analysis program 110A, 110B may calculate probabilities between the node elements of the selected most important node pairs and node triples. For example, for each binary relation R and each selected node pairs (A,B), syntactic analysis program 110A, 110B may determine the following statistics: probability of A and B and R independently, probability of A given B and R, probability of B given A and R, and probability of A and B given R. Then, for each ternary relation R and each selected node triple (A,B,C) for that ternary relation, syntactic analysis program 110A, 110B may determine the following statistics: probability of A and B and C and R, probability of A given B and C and R, probability of B given A and C and R, probability of C given B and A and R, probability of A and B given C and R, probability of A and C given B and R, probability of B and C given A and R, probability of A and B and C given R, and, finally, syntactic analysis program 110A, 110B may also collect the counts for the unary relation for each node A, and determine probability of node A.

Next, at 312, the syntactic analysis program 110A, 110B calculates statistics for each relation using the probability scores. According to at least one embodiment, the syntactic analysis program 110A, 110B may compute mean, max, min, standard deviation, and percentile scores over probability data, and use each score as a feature in a machine learning system, such as first for training a neural network on a body of text from a user with known mental impairment. In another embodiment, syntactic analysis program 110A, 110B may also compute average of the logarithms of the probability values divided by the number of elements in the data. In further embodiments, syntactic analysis program 110A, 110B may count the times any of the relations were observed in a text, determine a value of counts of the relations observed in a text divided by the total number of relations, count a number of times any node was observed in the text, and count a number of specific relations in each node divided by the total number of nodes.

Next, at 314, the syntactic analysis program 110A, 110B analyzes the calculated data using machine learning. According to at least one embodiment, syntactic analysis program 110A, 110B may incorporate a previously trained neural network that may analyze the data and determine a score that represents a neurological disorder associated with a score and associated probability that the score is accurate. In another embodiment, syntactic analysis program 110A, 110B may determine a treatment based on the score and its probability, such as giving an appropriate medication or treatment if the probability is above a threshold value.

Next, at 316, the syntactic analysis program 110A, 110B displays the machine learning output. According to at least one embodiment, the syntactic analysis program 110A, 110B may display the score, the neurological disorder associated with the score and a probability representing the likelihood that the mental impairment diagnosis is accurate. In another embodiment, the syntactic analysis program 110A, 110B may administer or recommend a treatment if the probability is above a threshold value. For example, if the threshold value is set to 95% and syntactic analysis program 110A, 110B determined that the user has dementia with associated probability of 96%, syntactic analysis program 110A, 110B may administer a specific medication to treat the user for dementia. In further embodiments, the administration of a medication may be automatic, such as by injecting the medication to the user.

It may be appreciated that FIG. 3 provides only an illustration of one implementation and does not imply any limitations with regard to how different embodiments may be implemented. Many modifications to the depicted environments may be made based on design and implementation requirements.

FIG. 4 is a block diagram 400 of internal and external components of the client computing device 102 and the server 112 depicted in FIG. 1 in accordance with an embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

The data processing system 402, 404 is representative of any electronic device capable of executing machine-readable program instructions. The data processing system 402, 404 may be representative of a smart phone, a computer system, PDA, or other electronic devices. Examples of computing systems, environments, and/or configurations that may represented by the data processing system 402, 404 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 402 a,b and external components 404 a,b illustrated in FIG. 4. Each of the sets of internal components 402 include one or more processors 420, one or more computer-readable RAMs 422, and one or more computer-readable ROMs 424 on one or more buses 426, and one or more operating systems 428 and one or more computer-readable tangible storage devices 430. The one or more operating systems 428, the software program 108 and the syntactic analysis program 110A in the client computing device 102, and the syntactic analysis program 110B in the server 112 are stored on one or more of the respective computer-readable tangible storage devices 430 for execution by one or more of the respective processors 420 via one or more of the respective RAMs 422 (which typically include cache memory). In the embodiment illustrated in FIG. 4, each of the computer-readable tangible storage devices 430 is a magnetic disk storage device of an internal hard drive. Alternatively, each of the computer-readable tangible storage devices 430 is a semiconductor storage device such as ROM 424, EPROM, flash memory or any other computer-readable tangible storage device that can store a computer program and digital information.

Each set of internal components 402 a,b also includes a R/W drive or interface 432 to read from and write to one or more portable computer-readable tangible storage devices 438 such as a CD-ROM, DVD, memory stick, magnetic tape, magnetic disk, optical disk or semiconductor storage device. A software program, such as the syntactic analysis program 110A, 110B, can be stored on one or more of the respective portable computer-readable tangible storage devices 438, read via the respective R/W drive or interface 432, and loaded into the respective hard drive 430.

Each set of internal components 402 a,b also includes network adapters or interfaces 436 such as a TCP/IP adapter cards, wireless Wi-Fi interface cards, or 3G or 4G wireless interface cards or other wired or wireless communication links. The software program 108 and the syntactic analysis program 110A in the client computing device 102 and the syntactic analysis program 110B in the server 112 can be downloaded to the client computing device 102 and the server 112 from an external computer via a network (for example, the Internet, a local area network or other, wide area network) and respective network adapters or interfaces 436. From the network adapters or interfaces 436, the software program 108 and the syntactic analysis program 110A in the client computing device 102 and the syntactic analysis program 110B in the server 112 are loaded into the respective hard drive 430. The network may comprise copper wires, optical fibers, wireless transmission, routers, firewalls, switches, gateway computers and/or edge servers.

Each of the sets of external components 404 a,b can include a computer display monitor 444, a keyboard 442, and a computer mouse 434. External components 404 a,b can also include touch screens, virtual keyboards, touch pads, pointing devices, and other human interface devices. Each of the sets of internal components 402 a,b also includes device drivers 440 to interface to computer display monitor 444, keyboard 442, and computer mouse 434. The device drivers 440, R/W drive or interface 432, and network adapter or interface 436 comprise hardware and software (stored in storage device 430 and/or ROM 424).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

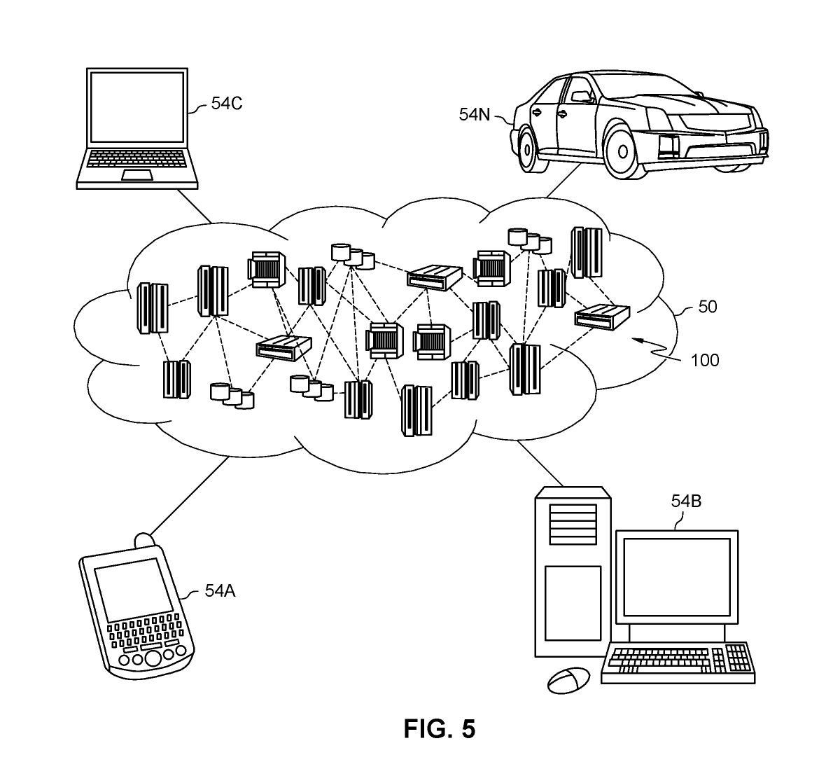

Referring now to FIG. 5, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 100 and cloud computing environment 50 can communicate with any type of computerized device over any type of network and/or network addressable connection (e.g., using a web browser).

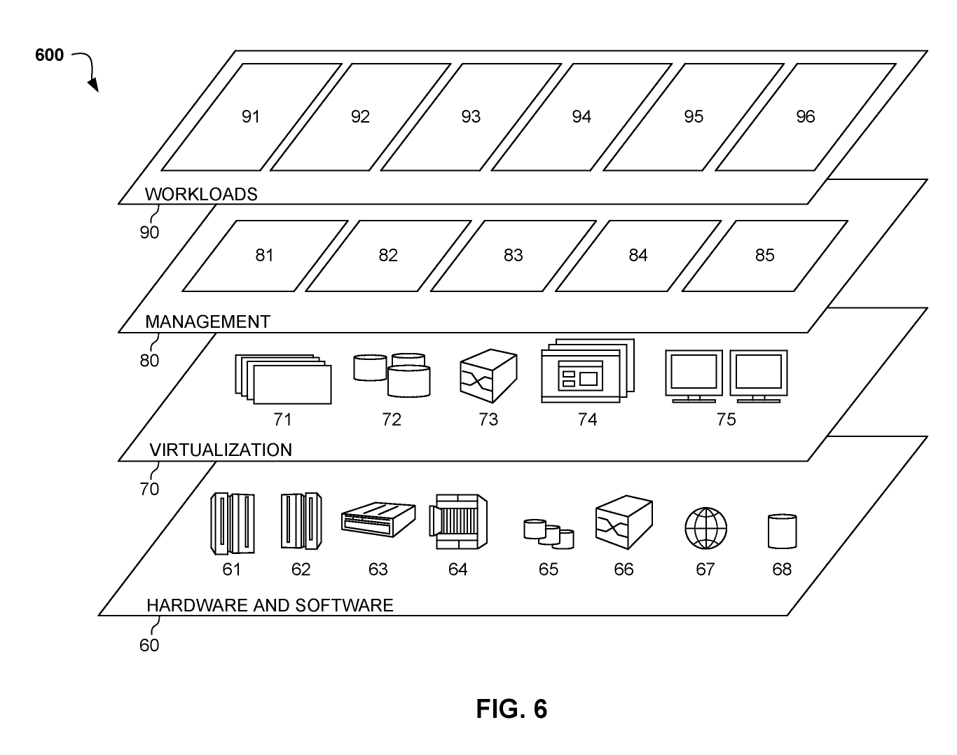

Referring now to FIG. 6, a set of functional abstraction layers 500 provided by cloud computing environment 50 is shown. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and syntactic analysis for inferring mental state 96. Syntactic analysis for inferring mental state may relate to determining a mental state of a user by converting the associated with the user text into a parse tree and determining whether important node pairs and node triples from the parsed tree are associated with a mental impairment.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for determining a mental state of a user by syntactic analysis of a text associated with the user, the method comprising:
receiving, by a processor, the text;
parsing the received text into a syntactic tree, wherein the syntactic tree comprises a plurality of node pairs and a plurality of node triples;
determining one or more binary relations and one or more trinary relations within the plurality of node pairs and the plurality of node triples, wherein the one or more binary relations are associated with the plurality of node pairs, and wherein the one or more trinary relations are associated with the plurality of node triples;
selecting a plurality of important node pairs from the plurality of node pairs and a plurality of important node triples from the plurality of node triples, wherein the plurality of the important node pairs and the plurality of the important node triples are determined by the binary relations and trinary relations, respectively;
calculating a plurality of probabilities within one or more relations of the plurality of the important node pairs and the plurality of the important node triples;
based on the calculated plurality of probabilities, calculating a plurality of statistics for the one or more relations;
determining a score and a probability associated with the score using the calculated plurality of probabilities and the calculated plurality of statistics with a trained neural network; and
displaying the determined score and the determined probability.

2. The method of claim 1, further comprising:
administering a treatment associated with the score based on determining that the probability is above threshold.

3. The method of claim 1, wherein selecting a plurality of important node pairs from the plurality of node pairs and a plurality of important node triples from the plurality of node triples further comprises:
arranging a plurality of counts of the plurality of node pairs and the plurality of node triples in a one or more matrices; and
determining a singular value decomposition of the one or more matrices.

4. The method of claim 1, wherein the trained neural network is trained on the text from one or more mentally impaired users.

5. The method of claim 1, wherein the binary relations are selected from a group consisting of a parent relation, a sister relation, a dominance relation, and a command relation.

6. The method of claim 1, wherein the trinary relations are selected from a group consisting of a command-via-maximal relation, a command-via-mother relation, and a dominate-transitive relation.

7. The method of claim 1, wherein the score is associated with a mental impairment diagnosis, and wherein the probability associated with a likelihood that the user suffers from the mental impairment.

8. A computer system for determining a mental state of a user by syntactic analysis of a text associated with the user, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving, by a processor, the text;
parsing the received text into a syntactic tree, wherein the syntactic tree comprises a plurality of node pairs and a plurality of node triples;
determining one or more binary relations and one or more trinary relations within the plurality of node pairs and the plurality of node triples, wherein the one or more binary relations are associated with the plurality of node pairs, and wherein the one or more trinary relations are associated with the plurality of node triples;
selecting a plurality of important node pairs from the plurality of node pairs and a plurality of important node triples from the plurality of node triples, wherein the plurality of the important node pairs and the plurality of the important node triples are determined by the binary relations and trinary relations, respectively;
calculating a plurality of probabilities within one or more relations of the plurality of the important node pairs and the plurality of the important node triples;
based on the calculated plurality of probabilities, calculating a plurality of statistics for the one or more relations;
determining a score and a probability associated with the score using the calculated plurality of probabilities and the calculated plurality of statistics with a trained neural network; and
displaying the determined score and the determined probability.

9. The computer system of claim 8, further comprising:
administering a treatment associated with the score based on determining that the probability is above threshold.

10. The computer system of claim 8, wherein selecting a plurality of important node pairs from the plurality of node pairs and a plurality of important node triples from the plurality of node triples further comprises:
arranging a plurality of counts of the plurality of node pairs and the plurality of node triples in a one or more matrices; and
determining a singular value decomposition of the one or more matrices.

11. The computer system of claim 8, wherein the trained neural network is trained on the text from one or more mentally impaired users.

12. The computer system of claim 8, wherein the binary relations are selected from a group consisting of a parent relation, a sister relation, a dominance relation, and a command relation.

13. The computer system of claim 8, wherein the trinary relations are selected from a group consisting of a command-via-maximal relation, a command-via-mother relation, and a dominate-transitive relation.

14. The computer system of claim 8, wherein the score is associated with a mental impairment diagnosis, and wherein the probability associated with a likelihood that the user suffers from the mental impairment.

15. A computer program product for determining a mental state of a user by syntactic analysis of a text associated with the user, the computer program product comprising:
one or more computer-readable tangible storage medium and program instructions stored on at least one of the one or more tangible storage medium, the program instructions executable by a processor, the program instructions comprising:
program instructions to receive, by a processor, the text;
program instructions to parse the received text into a syntactic tree, wherein the syntactic tree comprises a plurality of node pairs and a plurality of node triples;
program instructions to determine one or more binary relations and one or more trinary relations within the plurality of node pairs and the plurality of node triples, wherein the one or more binary relations are associated with the plurality of node pairs, and wherein the one or more trinary relations are associated with the plurality of node triples;
program instructions to select a plurality of important node pairs from the plurality of node pairs and a plurality of important node triples from the plurality of node triples, wherein the plurality of the important node pairs and the plurality of the important node triples are determined by the binary relations and trinary relations, respectively;
program instructions to calculate a plurality of probabilities within one or more relations of the plurality of the important node pairs and the plurality of the important node triples;
based on the calculated plurality of probabilities, program instructions to calculate a plurality of statistics for the one or more relations;
program instructions to determine a score and a probability associated with the score using the calculated plurality of probabilities and the calculated plurality of statistics with a trained neural network; and
program instructions to display the determined score and the determined probability.

16. The computer program of claim 15, further comprising:
program instructions to administer a treatment associated with the score based on determining that the probability is above threshold.

17. The computer program of claim 15, wherein selecting a plurality of important node pairs from the plurality of node pairs and a plurality of important node triples from the plurality of node triples further comprises:
program instructions to arrange a plurality of counts of the plurality of node pairs and the plurality of node triples in a one or more matrices; and
program instructions to determine a singular value decomposition of the one or more matrices.

18. The computer program of claim 15, wherein the trained neural network is trained on the text from one or more mentally impaired users.

19. The computer program of claim 15, wherein the binary relations are selected from a group consisting of a parent relation, a sister relation, a dominance relation, and a command relation.

20. The computer program of claim 15, wherein the trinary relations are selected from a group consisting of a command-via-maximal relation, a command-via-mother relation, and a dominate-transitive relation.
